(19) United States
(12) Patent Application Publication
(10) Pub. No.: US 2025/0381741 A1
(43) Pub. Date: Dec. 18, 2025

(54) FIBROUS REINFORCEMENT FOR THE MANUFACTURE OF A COMPOSITE PART INTENDED TO BE ARTICULATED WITH OTHER PARTS

(71) Applicants: SAFRAN LANDING SYSTEMS, VELIZY-VILLACOUBLAY (FR); SAFRAN, PARIS (FR)

(72) Inventors: Sylvain Didier LECLERCQ, MOISSY-CRAMAYEL (FR); Quentin ROIRAND, MOISSY-CRAMAYEL (FR); Dominique Marie Christian COUPE, MOISSY-CRAMAYEL (FR); Nicolas TRAN, MOISSY-CRAMAYEL (FR); Pietro DEL SORBO, MOISSY-CRAMAYEL (FR)

(21) Appl. No.: 18/877,994

(22) PCT Filed: Jun. 16, 2023
(86) PCT No.: PCT/FR2023/050878

§ 371 Date: Dec. 20, 2024

(30) Foreign Application Priority Data
Jun. 22, 2022 (FR) 2206162

(51) Int. Cl. B29C 70/22; B29K 105/08; B29K 307/04; B29L 31/30; D03D 15/275

(52) U.S. Cl. CPC B29C 70/22; D03D 15/275; B29K 2105/0845; B29K 2307/04; B29L 2031/3076; D10B 2101/12; D10B 2505/02

(57) ABSTRACT

A fibrous preform of a core portion of a fibrous reinforcement for a composite material part, the preform having an elongate shape along a longitudinal direction and being formed by three-dimensional weaving of first yarns extending along the longitudinal direction with second yarns transverse to the first yarns, the preform including two longitudinal ends for articulation with other parts and a median area located between the longitudinal ends, each longitudinal end having a thickness greater than a thickness of the median area, the median area having a first volume ratio of first yarns to second yarns that is greater than one, and each longitudinal end having a second volume ratio of first yarns to second yarns that is less than the first ratio and closer to one than this first ratio.

### TECHNICAL FIELD

The invention relates to a fibrous preform intended to form a portion of a fibrous reinforcement of a part made of composite material, which part is intended to be articulated with other parts at its ends, and to an associated manufacturing method.

### PRIOR ART

The use of composite materials to replace metal materials can be proposed with a view to lightening, which is a constant concern in the particular case of aircraft parts. To this end, document U.S. Pat. No. 7,704,429 proposed the manufacture of landing gear struts made of composite material which comprise regions, called forks, which are intended for articulation and the stress introduction with other parts and are formed by a laminated structure with intercalation of plies between primary plies extending the body of the reinforcement. This solution can nevertheless have disadvantages. Indeed, the forks that have a laminated configuration can lead to an increase in the size of the stress introduction areas compared to metal parts in order to avoid the risk of delamination. The mass saving of the overall system then becomes less interesting and the integration of the part more restrictive due to an increased space requirement. Another problem is that the proposed manufacturing technique implements a significant amount of manual work that can lead to non-conformities and an increase in cost. Finally, the mechanical performance of the composite material proposed in this document could be improved, especially in terms of compressive strength over a median area of the length of the part called the common area. One option to respond to this is to add material in the common area which penalizes the mass and therefore does not complete satisfaction.

The invention proposes to respond to all or part of the aforementioned disadvantages.

### DISCLOSURE OF THE INVENTION

The present invention relates to a fibrous preform of a core portion of a fibrous reinforcement for a composite material part, the preform having an elongate shape along a longitudinal direction and being formed by three-dimensional weaving of first yarns extending along the longitudinal direction with second yarns transverse to the first yarns, the preform comprising two longitudinal ends for articulation with other parts and a median area located between the longitudinal ends, each longitudinal end having a thickness greater than a thickness of the median area, the median area having a first volume ratio of first yarns to second yarns that is greater than one, and each longitudinal end having a second volume ratio of first yarns to second yarns that is less than the first ratio and closer to one than this first ratio.

The volume ratio of the first yarns to the second yarns corresponds to the ratio [volume occupied by the first yarns]/[volume occupied by the second yarns]. For purposes of brevity, this ratio may be designated hereinafter by the term “F1/F2 ratio”. In the particular case where the first yarns correspond to the warp yarns, this ratio corresponds to the warp/weft ratio. In a variant, the first yarns may correspond to the weft yarns and the second yarns to the warp yarns.

The invention proposes an optimized design of a core preform of a fibrous reinforcement of the core-belt assembly type, which is based on the three-dimensional weaving technique and on articulation areas with excess thickness with regard to the median area, or common area, in order to obtain improved resistance to forces. Furthermore, it is proposed to rebalance the F1/F2 ratio in these articulation regions so as to control the fiber content while allowing a design with a constant or substantially constant number of layers of first yarns over the entire length of the preform. The manufacture is therefore repeatable by eliminating manual steps as much as possible, and leads to a reinforcement of improved quality by avoiding, or by greatly limiting, the local addition of first yarns to the ends with excess thickness and their subsequent cutting which may result in non-conformities in production due to slight residual overlengths.

In one embodiment, each longitudinal end has a spacing between consecutive columns of second yarns that is less than a spacing between consecutive columns of second yarns in the median area.

Such a characteristic constitutes a first solution to allow modifying the F1/F2 ratio so as to rebalance it at the longitudinal ends.

In a variant or in combination, each longitudinal end has a weight of the second yarns greater than a weight of the second yarns in the median area.

Such a characteristic constitutes a second solution to allow modifying the F1/F2 ratio so as to rebalance it at the longitudinal ends.

Of course, it is possible to modify the F1/F2 ratio by modifying both the inter-column spacing and the weight of the second yarns.

In an exemplary embodiment, the preform defines, on upper and lower sides, positioning edges having a transverse dimension, measured transversely to the longitudinal direction, that evolves and passes through a maximum in the median area.

This increased transverse dimension increases the inertia of the part, which is beneficial for buckling, bending and certain vibratory modes. In addition, the strength of the interface increases with the increasing surface.

In an exemplary embodiment, the preform is made of carbon yarns.

The invention also relates to a method for manufacturing a fibrous reinforcement of a composite material part, comprising:
positioning a woven fibrous belt texture on a preform of a core portion as described above, the belt texture defining a loop around the preform of the core portion so as to define, at the longitudinal ends, free spaces intended for articulation with other parts.

In one embodiment, the belt texture is made of carbon yarns.

The invention also concerns a method of manufacturing a composite part intended to be articulated with other parts, comprising:
forming a fibrous reinforcement as described above; and
forming a matrix in a porosity of the fibrous reinforcement thus obtained.

In one embodiment, the matrix is an organic matrix.

In one exemplary embodiment, the part is a landing gear strut, part of a landing gear strut, or a brake bar.

### BRIEF DESCRIPTION OF THE DRAWINGS

FIG. 1 shows an example of a fibrous core preform according to the invention.

FIG. 2A shows the cross-section of the preform of FIG. 1 over a first area of its length.

FIG. 2B shows the cross-section of the preform of FIG. 1 over a second area of its length.

FIG. 2C shows the cross-section of the preform of FIG. 1 over a third area of its length.

FIG. 3 shows a detail of an example of a longitudinal end of a core preform according to the invention.

FIG. 4 shows a detail of an example of a longitudinal end of a core preform according to the invention.

FIG. 5 shows a fibrous reinforcement of a composite material part obtained after positioning the belt texture on the preform of FIG. 1.

### DESCRIPTION OF THE EMBODIMENTS

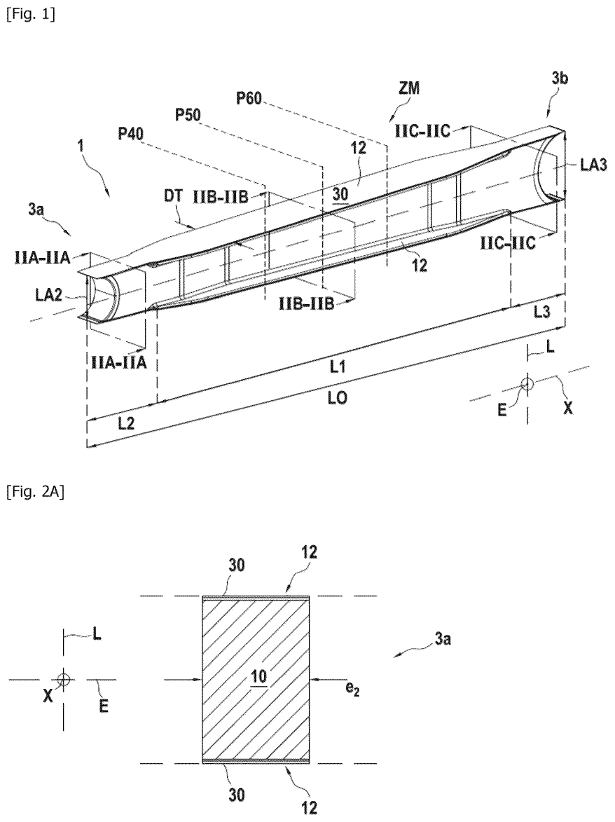

FIG. 1 shows a fibrous preform 1 of a core of a fibrous reinforcement for a part made of composite material. The preform 1 has an elongate shape extending along a longitudinal direction X. It can be obtained by three-dimensional weaving in a single piece using, for example, an “interlock” pattern weave. The term “three-dimensional weaving” or “3D weaving” is understood to mean a weaving method by which at least some of the first yarns directed in the direction X bind second yarns transverse to the first yarns on several layers of second yarns. Such weaving can be carried out on a Jacquard type loom, in a manner known per se. The preform 1 comprises, successively along the direction X, a first longitudinal end 3a, a median area ZM and a second longitudinal end 3b. Each of the first end 3a, the median area ZM and the second end 3b can be obtained by three-dimensional weaving and can be located in the textile extension of one another. The median area ZM may be designed to be subjected to tensile and compressive forces. The longitudinal ends 3a, 3b have a curved shape, for example substantially circular, and are intended to define, in the part to be obtained, free spaces dedicated to articulation with other parts. According to one example, the median area ZM may have a length L1 comprised between 50% and 98% of the length LO of the preform 1 and each end 3a, 3b may have a length L2, L3 comprised between 1% and 25% of the length LO. The lengths are measured along the direction X. The median area ZM can be centered with regard to a plane P50 located halfway along the length of the preform 1 and perpendicular to the direction X. The longitudinal ends 3a, 3b here have different dimensions and especially different widths LA2, LA3, which are measured along the width direction L. The preform 1 defines, on its upper and lower sides, positioning edges 12 extending along the longitudinal direction X and defining a surface 30 for positioning the belt texture. The transverse dimension DT of the positioning edges 12 in the median area ZM is greater than that in the ends 3a, 3b.

This dimension DT may, as illustrated, increase over the median area ZM when moving from the first end 3a, be maximum in the vicinity of the mid-length plane P50 of the preform 1, for example at least over the section located between the planes P40 and P60 located at 40% and at 60% of the length LO and perpendicular to the direction X, and then decrease over the median area ZM in the direction of the second end 3b. In cross-section, the preform 1 comprises a central portion 10 which has on its upper and lower sides the two positioning edges 12. In the example illustrated, the edges 12 and the central portion 10 are offset along the width (direction L). The preform 1 may be obtained by three-dimensional weaving of a fibrous strip in one piece, providing non-interlinking areas so as to form the positioning edges 12 after folding down the non-interlinked portions 16a and 16b.

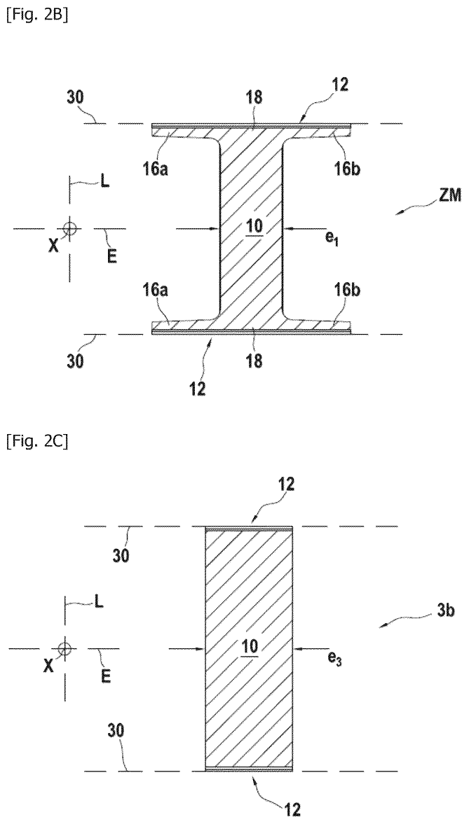

An intermediate portion 18 making it possible to obtain a positioning surface 30 of generally flat shape may be present between the portions 16a and 16b and may be obtained by cutting a non-interlinked intermediate texture from the portions 16a and 16b. In the example illustrated and as illustrated in FIGS. 2A to 2C, the thickness e2 of the first end 3a is greater than the thickness e1 of the median area ZM. The thickness e3 of the second end 3b is less than the thickness e2 but greater than the thickness e1. The thicknesses are measured along the thickness direction (direction E) and correspond to the smallest dimension. According to one example, the e2/e1 ratio may be greater than 1 and less than or equal to 4, for example comprised between 1.5 and 2.5, and the e3/e1 ratio may be greater than 1 and less than or equal to 4, for example between 1.5 and 2.5. As illustrated, the preform 1 may have an I-shape (called a double angle shape) in cross-section with regard to the longitudinal direction X. In the example illustrated, the positioning edges 12 each form an angle substantially equal to 90° with the direction L. The positioning edges 12 form lateral fins for positioning the belt texture. The preform 1 defines, at the positioning edges 12, the positioning surface 30 on which the belt texture is intended to be deposited.

As indicated above, the F1/F2 ratio in the ends 3a and 3b is less than the F1/F2 ratio in the median area ZM and closer to one than the latter. Thus, the absolute value of the difference [(second volume ratio of first yarns to second yarns)−1] is smaller than the difference [(first volume ratio of first yarns to second yarns)−1].

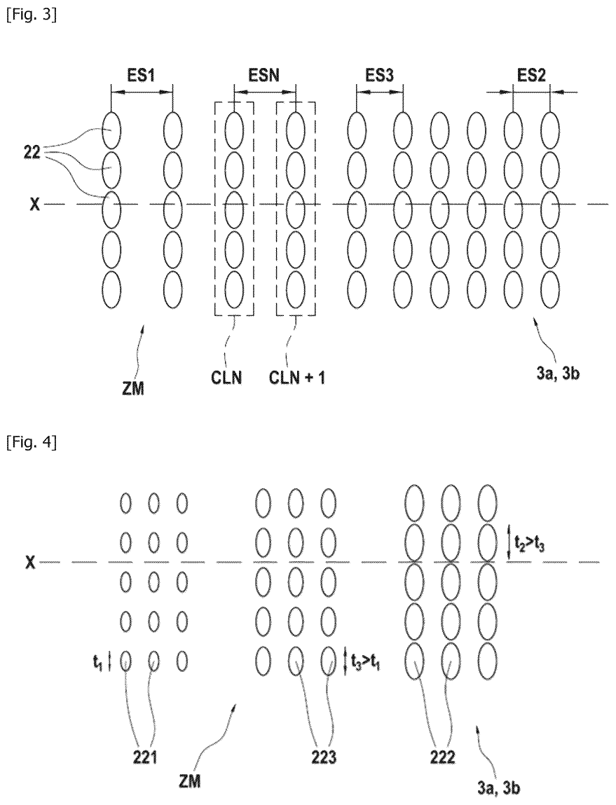

According to one example, the F1/F2 ratio in the median area ZM may be comprised between 1.2 and 9, and the F1/F2 ratio in the ends 3a and 3b may be comprised between 0.6 and 4. It will be noted that the ends 3a and 3b may have an identical or different F1/F2 ratio. FIGS. 3 and 4 show different ways of varying the F1/F2 ratio. In the example of FIG. 3, the spacing ESN between consecutive columns CLN and CLN+1 of second yarns 22 is modified so as to decrease to a value ES2 in an end region 3a, 3b lower than a value ES1 in the median area ZM. As illustrated, this change can be made gradually by passing through one or more intermediate values ES3 less than ES1 while being greater than ES2. According to one example, the ES1/ES2 ratio may be between 1 and 5. FIG. 4 shows the case in which the weight of the second yarns is increased in the end region 3a, 3b relative to the median area ZM between a first weight t1 and a second weight t2 (yarns 221 with weight t1 and yarns 222 with weight t2). This progression can be gradual by passing through second yarns 223 having one or more intermediate weights t3 greater than t1 while being less than t2.

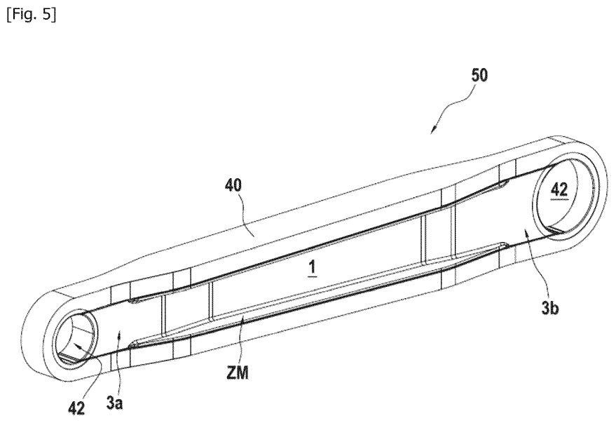

An example of a preform 1 according to the invention has just been described. This preform 1 is intended only to form part of the fibrous reinforcement 50 of the composite material part to be obtained. The following describes the subsequent manufacture of the part which includes the positioning around the preform 1 of a woven belt texture 40, as illustrated in FIG. 5. The texture 40 may be in the form of a strip which is wound around the preform 1. During its positioning, the texture 40 comes to bear on the positioning surface 30. The texture 40 may be in the form of a single strip of fabric, but it would not exceed the scope of the invention if it was in the form of several strips placed end to end or side to side. The texture 40 can also be obtained by three-dimensional weaving, for example with an interlock weave. The texture 40 defines a closed loop around the preform 1 and defines free spaces 42 intended for articulation with the other parts. The texture 40 can follow the shape of the positioning edges 12 so as to cover them entirely. Inserts (not shown) can be used temporarily at the longitudinal ends 3 and the second texture 40 can be wound around them so as to guarantee the desired shape for the end regions. The entire preform 1 and texture 40 are then densified, for example by introducing a resin, such as an epoxy resin, followed by cross-linking the resin if it is a thermosetting resin or cooling if it is a thermoplastic resin. The matrix may be formed by a resin transfer molding technique which corresponds to a technique known per se. A composite material part is thus obtained intended to be articulated with other parts at its longitudinal ends. The fibrous reinforcement 50 of the part may be formed of carbon yarns and the part may have an organic matrix as has just been described. The part may or may not be intended for an aeronautical application. The part may, for example, be a connecting rod, a landing gear strut or a component thereof, or a brake bar. The part obtained can be mounted to other parts by positioning through the free spaces 42 a hinge pin for connection to other parts as well as an insert for contact with this pin.

1. A fibrous preform of a core portion of a fibrous reinforcement for a part of composite material, the preform having an elongate shape along a longitudinal direction and being formed by three-dimensional weaving of first yarns extending along the longitudinal direction with second yarns transverse to the first yarns;
the preform comprising two longitudinal ends intended for articulation with other parts and a median area located between the longitudinal ends, each longitudinal end having a thickness greater than a thickness of the median area, the median area having a first volume ratio of first yarns to second yarns which is greater than one, and each longitudinal end having a second volume ratio of first yarns to second yarns which is less than the first ratio and closer to one than this first ratio,
wherein the preform defines, on upper and lower sides, positioning edges having a transverse dimension, measured transversely to the longitudinal direction, that evolves and passes through a maximum in the median area.

2. The fibrous preform according to claim 1, wherein each longitudinal end has a spacing between consecutive columns of second yarns that is less than a spacing between consecutive columns of second yarns in the median area.

3. The fibrous preform according to claim 1, wherein each longitudinal end has a weight of the second yarns greater than a weight of the second yarns in the median area.

4. (canceled)

5. The fibrous preform according to claim 1 4, wherein the preform is made of carbon yarns.

6. A method for manufacturing a fibrous reinforcement of a composite material part, the method comprising:
positioning a woven fibrous belt texture on a preform of a core portion according to claim 1, the woven fibrous belt texture defining a loop around the preform of the core portion so as to define, at the longitudinal ends, free spaces intended for articulation with other parts.

7. The method according to claim 6, wherein the woven fibrous belt texture is made of carbon yarns.

8. A method of manufacturing a composite part intended to be articulated with other parts, the method comprising:
forming a fibrous reinforcement according to claim 6, and
forming a matrix in a porosity of the fibrous reinforcement thus obtained.

9. The method according to claim 8, wherein the matrix is an organic matrix.

10. The method according to claim 8, wherein the component is a landing gear strut, a portion of a landing gear strut or a brake bar.

11. A method of manufacturing a composite part intended to be articulated with other parts, the method comprising:
forming a fibrous reinforcement according to claim 7, and
forming a matrix in a porosity of the fibrous reinforcement thus obtained.

12. The method according to claim 9, wherein the component is a landing gear strut, a portion of a landing gear strut or a brake bar.
